(19) United States
(12) Patent Application Publication
(10) Pub. No.: US 2008/0187891 A1
(43) Pub. Date: Aug. 7, 2008

(54) Phonetic teaching/correcting device for learning mandarin

(76) Inventor: Chen Ming Yang, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/896,780

(22) Filed: Sep. 6, 2007

Related U.S. Application Data
(63) Continuation-in-part of application No. 11/717,721, filed on Mar. 14, 2007.

(30) Foreign Application Priority Data
Feb. 1, 2007 (TW) 096201978

(51) Int. Cl. G09B 19/00

(52) U.S. Cl. 434/156

(57) ABSTRACT

A phonetic teaching/correcting device for learning Mandarin includes a book having a plurality of pages. At least one of the pages includes a Chinese character. Also provided on the same page are first and second phonetic symbol components and a tone mark that together form a phonetic symbol combination representing pronunciation of the Chinese character. Also provided on the same page are marks in association with pronunciation of the Chinese character and each phonetic symbol component. A speaker outputs pronunciation of one of the Chinese character and the phonetic symbol components scanned by a reader.

### CROSS REFERENCE TO RELATED APPLICATION

This is a continuation-in-part application of U.S. patent application Ser. No. 11/717,721 filed Mar. 14, 2007.

### BACKGROUND OF THE INVENTION

1. Field of the Invention

The present invention relates to a phonetic teaching/correcting device for learning language and, more particularly, to a phonetic teaching/correcting device for learning Mandarin.

2. Description of the Related Art

Language is a key to culture contact, merging into a society, etc. The rise of the Mainland China in economics has brought a global tide in learning Chinese or Mandarin. There are two types of Mandarin characters: Simplified Chinese characters mainly used in Mainland China and having a phonetic system named “Hanyu Pinyin” or simply “Pinyin”; and Traditional Chinese characters mainly used in Taiwan and having a phonetic system named “Zhuyin fuhao” (often abbreviated as “Zhuyin”, or known as “Bopomofo”). Despite of differences in learning, the two language systems of Mandarin have many things in common. For example, Simplified characters and Traditional characters are substantially the same in pronunciation and meaning in addition to similarity between different shapes.

Mandarin can be learned in regular schools or clam schools. Pronunciation is the primary threshold of any methods for learning Mandarin. The learners will severely mispronounce words and hence require correction if they receive wrong teachings from their teachers or through non-standard learning systems. Even if the teachers teach correct pronunciation, the teachers are not available at any time while repeated pronunciation is not pleasant to the teachers during the class. In view of high cost and inconvenience encountered during learning Mandarin, there is a need in a teaching/correcting device to allow repeated teaching or correction of pronunciation of Mandarin in an economic and efficient way in this modern world full of advanced technology, for repeated practice is the key to learning language.

### SUMMARY OF THE INVENTION

The present invention provides a phonetic teaching/correcting device for learning Mandarin including a plurality of Chinese characters and a phonetic system that includes a first group of phonetic symbols, a second group of phonetic symbols, and a plurality of tone marks representing a plurality of tones.

The phonetic teaching/correcting device for learning Mandarin according to the preferred teachings of the present invention includes a book and a reading device. The book includes a plurality of pages at least one of which includes a first phonetic symbol component selected from one of the first group of phonetic symbols and a second phonetic symbol component selected from one of the second group of phonetic symbols. On the same page there is a first Chinese character whose pronunciation is represented by the first and second symbol components and one of the tone marks. On the same page there is a first mark within or beside the first phonetic symbol component and a second mark within or beside the first phonetic symbol component. The first mark is in association with pronunciation of the first phonetic symbol component, and the second mark is in association with pronunciation of the second phonetic symbol component.

The reading device includes a reader for identifying the first and second marks, a processing unit, and a memory storing pronunciation information of a plurality of Chinese characters including the first Chinese character. The processing unit receives and processes the identification result of the reader and outputs information of pronunciation of one of the first and second phonetic symbol components read by the reader. The reading device further includes an audio playing device connected to the processing unit for outputting the pronunciation of one of the first and second phonetic symbol components read by the reader.

The first and second phonetic symbols are selected from Zhuyin fuhao system or Hanyu Pinyin system.

The second phonetic symbol component may consist of two phonetic symbols being pronounced in a rapid, continuous way to produce a phonation.

The reader can be a barcode reader, an IC reader, a magnetic strip reader, a radio frequency identification reader, or an optical character recognition reader.

The phonetic teaching/correcting device according to the preferred teachings of the present invention allows repeated practice of correct pronunciation of phonetic symbols and Chinese characters in an economic and efficient way.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of a reading device of a phonetic teaching/correcting device according to the preferred teachings of the present invention.

FIG. 2 is a perspective view of an embodiment of a book of the phonetic teaching/correcting device according to the preferred teachings of the present invention.

FIG. 3 is an enlarged view of a phonetic symbol on a page of the book of FIG. 2.

FIG. 4 is a plan view of another embodiment of the book of the phonetic teaching/correcting device according to the preferred teachings of the present invention.

FIG. 5 is an enlarged view of a phonetic symbol on a page of the book of FIG. 4.

FIG. 6 is a further embodiment of the book of the phonetic teaching/correcting device according to the preferred teachings of the present invention.

FIG. 7 is still another embodiment of the book of the phonetic teaching/correcting device according to the preferred teachings of the present invention.

### DETAILED DESCRIPTION OF THE PREFERRED EMBODIMENTS

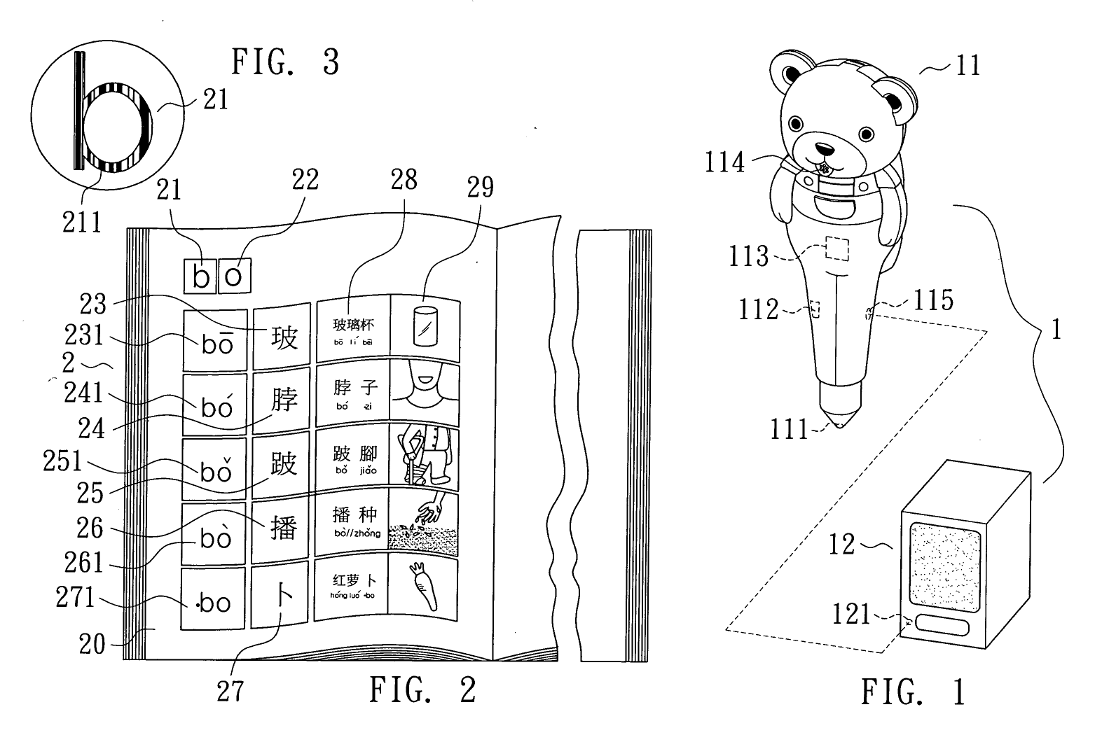

A phonetic teaching/correcting device according to the preferred teachings of the present invention includes a reading device 1 and a book. The book may be of any form including but not limited to the books 2, 2A, 2B, 2C respectively shown in FIGS. 2-3 and 6-7, which will be described hereinafter.

With reference to FIG. 1, the reading device 1 of the phonetic teaching/correcting device according to the preferred teachings of the present invention includes a reader 11 such as a barcode reader, IC reader, magnetic strip reader, radio frequency identification (RFID) reader, or optical character recognition reader. Specifically, the reader 11 includes a reading element 111 and a processing unit 112 that is connected to a memory 113. The memory 113 may be a built-in memory or an external memory card in which correct pronunciations of Chinese characters in the book 2, 2A, 2C, 2D are stored. The reader 11 further includes an audio playing device that is connected to the processing unit 112 for converting processed information into an audio signal such that the pronunciation of a specific character on the book scanned by the reader 11 can be output by the audio playing device. In an example, the audio playing device is a speaker 114 built in the reader 11. In another example, the audio playing device includes a wireless transmitter 115 built in the reader 11 and connected to the processing unit 112. The audio playing device further includes a speaker 12 that is located outside the reader 11 and that has a wireless receiver 121 mounted thereto. Processed information can be converted into an audio signal and sent by the wireless transmitter 115 to the wireless receiver 121 and output by the speaker 12. Thus, the pronunciation of a phonetic symbol or Chinese character on the book 2, 2A, 2B, 2C scanned by the reader 11 can be output through the speaker 12.

An embodiment of the book using Hanyu Pinyin system and Simplified Chinese characters is shown in FIG. 2 and designated “2”. Pronunciation of each Chinese character can be represented by a phonetic symbol combination including a phonetic symbol combination basis and one of five tones of the Hanyu Pinyin phonetic system, wherein the phonetic symbol combination basis includes at least one phonetic symbol. The five tones of the Hanyu Pinyin phonetic system can be represented by five tone marks including “-” (which can be omitted) for the first tone, [symbol] for the second tone, [symbol] for the third tone, [symbol] for the fourth tone, and “” for the fifth tone.

The book 2 includes a plurality of pages 20. At least one of the pages 20 includes a first phonetic symbol component 21 selected from a first group of phonetic symbols including but not limited to “b”, “p”, “m”, “f”, “d”, “t”, “n”, “l”, “g”, “k”, “h”, “j”, “q”, “x”, “zh”, “ch”, and “sh”. In the example shown, the first phonetic symbol component 21 is “b”. The page 20 further includes a second phonetic symbol component 22 selected from a second group of phonetic symbols including but not limited to “a”, “o”, “e”, “ie”, “ai”, “ei”, “ao”, “ou”, “an”, “en”, “ang”, “eng”, “er”, “i”, “u”, and “ü”. In the example shown, the second phonetic symbol component 22 is “o” and located beside the first phonetic symbol component 21. The first and second phonetic symbol components 21 and 22 form a phonetic symbol combination basis.

Five Chinese character 23-27 (see the Simplified Chinese characters [symbol] [symbol] and [symbol] are provided on the same page 20. These Chinese characters 23-27 have the same Hanyu Pinyin symbol components 231, 241, 251, 261, and 271 as the phonetic symbol combination basis but have five different tones (see the different tone marks). Furthermore, derivative Chinese words 28 derived from the Chinese characters 23-27 and corresponding drawings 29 can be provided on the same page 20.

A mark 211 is provided within or beside each of the first phonetic symbol component 21, the second phonetic symbol component 22, the Chinese characters 23-27, the derivative Chinese words 28, and the corresponding drawings 29. The mark 211 contains pronunciation information in association with the corresponding one of the first phonetic symbol component 21, the second phonetic symbol component 22, the Chinese characters 23-27, the derivative Chinese words 28, and the corresponding drawings 29. As an example, a barcode 211 is contained in the phonetic symbol component 21 (see FIG. 3).

In a case that the reader 11 is a barcode reader, IC reader, magnetic strip reader, or RFID reader, the mark 211 can be a barcode. In another case that the reader 11 is an optical character recognition reader, the mark 211 is exactly the corresponding one of the first phonetic symbol component 21, the second phonetic symbol component 22, the Chinese characters 23-27, the derivative Chinese words 28, and the corresponding drawings 29. After reading the mark 211 with the optical character recognition reader, the shape of the mark 211 is identified by built-in software in the optical character recognition reader and converted into an audio signal and then output via the speaker 114 or the speaker 12.

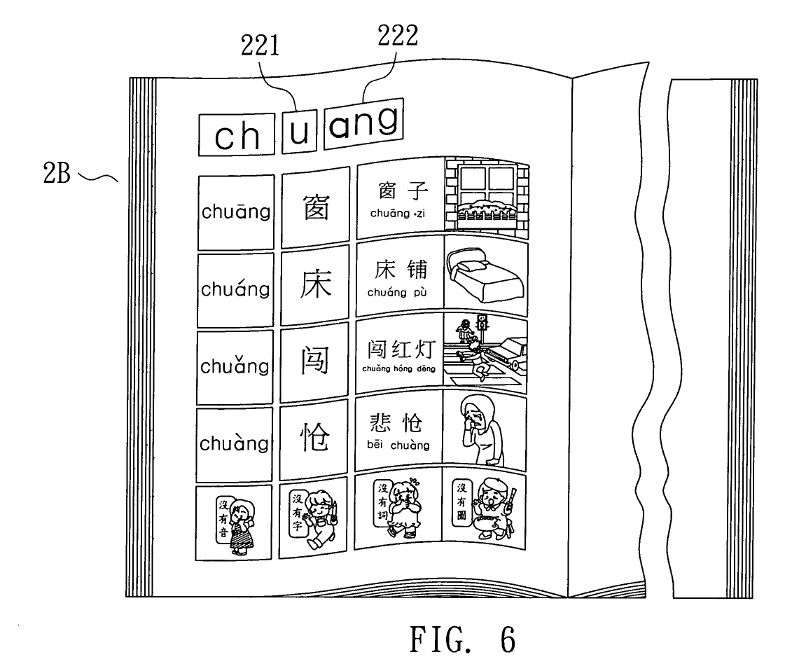

In another embodiment of the book 2B shown in FIG. 6, the second phonetic symbol component includes two phonetic symbols “u” and “ang” 221 and 222. The two phonetic symbols 221 and 222 can be pronounced in a rapid, continuous way to produce a phonation.

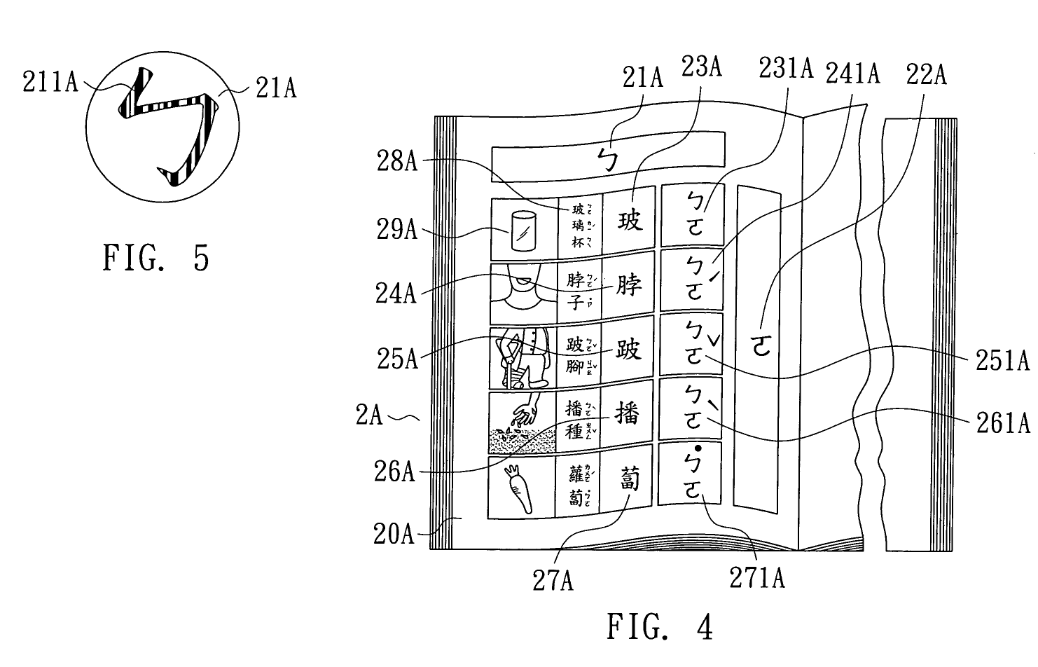

A further embodiment of the book using Zhuyin fuhao system and Traditional Chinese characters is shown in FIG. 4 and designated “2A”. Pronunciation of each Chinese character can be represented by a phonetic symbol combination basis and one of five tones of the Zhuyin fuhao phonetic system. The five tones of the Zhuyin fuhao phonetic system can be represented by five tone marks including “-” (which can be omitted) for the first tone, [symbol] for the second tone, [symbol] for the third tone, [symbol] for the fourth tone, and “” for the fifth tone.

The book 2A includes a plurality of pages 20A. At least one of the pages 20A includes a first phonetic symbol component 21A selected from a first group of phonetic symbols including but not limited to [symbol] [symbol] [symbol] [symbol] [symbol] [symbol] [symbol] [symbol] [symbol] [symbol] and [symbol] In the example shown, the first phonetic symbol component 21A is [symbol] . The page 20A further includes a second phonetic symbol component 22A selected from a second group of phonetic symbols including but not limited to [symbol] [symbol] [symbol] [symbol] [symbol] [symbol] [symbol] [symbol] and [symbol] In the example shown, the second phonetic symbol component 22A is [symbol] The first and second phonetic symbol components 21A and 22A form a phonetic symbol combination basis.

Five Chinese character 23A-27A (see the Simplified Chinese characters [symbol] [symbol] [symbol] and [symbol] are provided on the same page 20A. These Chinese characters 23A-27A have the same Zhuyin fuhao symbol components 231A, 241A, 251A, 261A, and 271A as the phonetic symbol combination basis but have five different tones (see the different tone marks). Furthermore, derivative Chinese words 28A derived from the Chinese characters 23A-27A and corresponding drawings 29A can be provided on the same page 20A.

A mark 211A is provided within or beside each of the first phonetic symbol component 21A, the second phonetic symbol component 22A, the Chinese characters 23A-27A, the derivative Chinese words 28A, and the corresponding drawings 29A. The mark 211A contains pronunciation information in association with the corresponding one of the first phonetic symbol component 21A, the second phonetic symbol component 22A, the Chinese characters 23A-27A, the derivative Chinese words 28A, and the corresponding drawings 29A. As an example, a barcode 211A is contained in the phonetic symbol component 21A (see FIG. 5).

In a case that the reader 11 is a barcode reader, IC reader, magnetic strip reader, or RFID reader, the mark 211A can be a barcode. In another case that the reader 11 is an optical character recognition reader, the mark 211A is exactly the corresponding one of the first phonetic symbol component 21A, the second phonetic symbol component 22A, the Chinese characters 23A-27A, the derivative Chinese words 28A, and the corresponding drawings 29A. After reading the mark 211A with the optical character recognition reader, the shape of the mark 211A is identified by built-in software in the optical character recognition reader and converted into an audio signal and then output via the speaker 114 or the speaker 12.

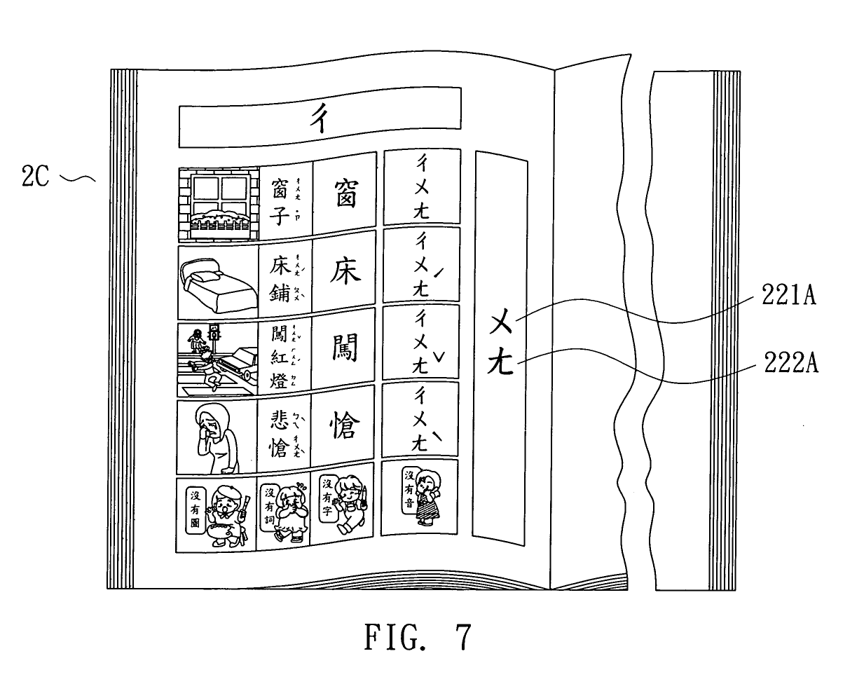

In still another embodiment of the book 2C shown in FIG. 7, the second phonetic symbol component includes two phonetic symbols [symbol] and [symbol] 221A and 222A. The two phonetic symbols 221A and 222A can be pronounced in a rapid, continuous way to produce a smooth phonation.

The phonetic teaching/correcting device according to the preferred teachings of the present invention allows repeated practice of correct pronunciation of phonetic symbols and Chinese characters in an economic and efficient way.

Although specific embodiments have been illustrated and described, numerous modifications and variations are still possible without departing from the teachings of the invention. The scope of the invention is limited by the accompanying claims.

What is claimed is:

1. A phonetic teaching/correcting device for learning Mandarin, with the Mandarin including a plurality of Chinese characters and a phonetic system that includes a first group of phonetic symbols, a second group of phonetic symbols, and a plurality of tone marks representing a plurality of tones, with the phonetic teaching/correcting device comprising:
a book including a plurality of pages, with at least one of the plurality of pages including a first phonetic symbol component selected from one of the first group of phonetic symbols and a second phonetic symbol component selected from one of the second group of phonetic symbols, with said at least one of the plurality of pages further including a first Chinese character whose pronunciation is represented by the first and second symbol components and one of the plurality of tone marks, with said at least one of the plurality of pages further including a first mark within or beside the first phonetic symbol component and a second mark within or beside the first phonetic symbol component, with the first mark being in association with pronunciation of the first phonetic symbol component, and with the second mark being in association with pronunciation of the second phonetic symbol component; and
a reading device including a reader for identifying the first and second marks, a processing unit, and a memory storing pronunciation information of a plurality of Chinese characters including the first Chinese character, with the processing unit receiving and processing identification result of the reader and outputting information of pronunciation of one of the first and second phonetic symbol components read by the reader, with the reading device further including an audio playing device connected to the processing unit for outputting the pronunciation of one of the first and second phonetic symbol components read by the reader.

2. The phonetic teaching/correcting device for learning Mandarin as claimed in claim 1, with said at least one of the plurality of pages further including a phonetic symbol combination beside the first Chinese character, with the phonetic symbol combination including third and fourth phonetic symbol components and said one of the plurality of tone marks, and with the third and fourth phonetic symbol components being identical to the first phonetic symbol components, respectively.

3. The phonetic teaching/correcting device for learning Mandarin as claimed in claim 2, further comprising a third mark within or beside the phonetic symbol combination, with the third mark being in association with pronunciation of the first Chinese character, with the third mark being readable by the reader, and with the pronunciation of the first Chinese character being output by the audio playing device when the third mark is read by the reader.

4. The phonetic teaching/correcting device for learning Mandarin as claimed in claim 1, with the audio playing device including a speaker built in the reader.

5. The phonetic teaching/correcting device for learning Mandarin as claimed in claim 1, with the audio playing device including a speaker outside the reader, a wireless receiver mounted in the speaker, and a wireless transmitter built in the reader and connected to the processing unit, with the wireless transmitter transmitting an audio signal indicative of the pronunciation of one of the first and second phonetic symbol components read by the reader to the wireless receiver, and with the speaker outputting the pronunciation of one of the first and second phonetic symbol components read by the reader.

6. The phonetic teaching/correcting device for learning Mandarin as claimed in claim 1, with said at least one of the plurality of pages further including a plurality of additional Chinese characters each of which having a pronunciation represented by third and fourth phonetic symbol components and a tone, with the third and fourth phonetic symbol components being identical to the first and second phonetic symbol components, and with the tones of the plurality of additional Chinese characters being different from each other and different from that of the first Chinese character.

7. The phonetic teaching/correcting device for learning Mandarin as claimed in claim 6, with a phonetic symbol combination being provided beside each of the plurality of additional Chinese characters, with each of the phonetic symbol combinations including third and fourth phonetic symbol components respectively identical to the first and second phonetic symbol components, and with the phonetic symbol combinations representing pronunciation of the additional Chinese characters including tone marks different from each other and different from that of the first Chinese character.

8. The phonetic teaching/correcting device for learning Mandarin as claimed in claim 7, further comprising a plurality of third marks respectively within or beside the phonetic symbol combinations representing pronunciation of the additional Chinese characters, with the plurality of third marks being in association with pronunciation of the additional Chinese characters, with the plurality of third marks being readable by the reader, and with the pronunciation of one of the additional Chinese characters being output by the audio playing device when one of the third marks is read by the reader.

9. The phonetic teaching/correcting device for learning Mandarin as claimed in claim 1, with said at least one of the plurality of pages further including a derivative Chinese word derived from the first Chinese character.

10. The phonetic teaching/correcting device for learning Mandarin as claimed in claim 9, with said at least one of the plurality of pages further including a drawing corresponding to the derivative Chinese word derived from the first Chinese character.

11. The phonetic teaching/correcting device for learning Mandarin as claimed in claim 10, further comprising a third mark within or beside the derivative Chinese word or the drawing, with the third mark being in association with pronunciation of the derivative Chinese word, with the third mark being readable by the reader, and with the pronunciation of the derivative Chinese word being output by the audio playing device when the third mark is read by the reader.

12. The phonetic teaching/correcting device for learning Mandarin as claimed in claim 6, with said at least one of the plurality of pages further including a plurality of derivative Chinese words respectively derived from the additional Chinese characters.

13. The phonetic teaching/correcting device for learning Mandarin as claimed in claim 12, with said at least one of the plurality of pages further including a plurality of drawings respectively corresponding to the derivative Chinese words derived from the additional Chinese characters.

14. The phonetic teaching/correcting device for learning Mandarin as claimed in claim 13, with said at least one of the plurality of pages further including a plurality of third marks respectively within or beside the plurality of derivative Chinese words or the plurality of drawings, with the plurality of third marks being respectively in association with the pronunciations of the derivative Chinese words, and with the speaker outputting the pronunciation of one of the derivative Chinese words when one of the third marks is scanned by the reader.

15. The phonetic teaching/correcting device for learning Mandarin as claimed in claim 1, with the first and second phonetic symbols being selected from one of Zhuyin fuhao system and Hanyu Pinyin system.

16. The phonetic teaching/correcting device for learning Mandarin as claimed in claim 1, with the second phonetic symbol component consisting of two phonetic symbols being pronounced in a rapid, continuous way to produce a phonation.

17. The phonetic teaching/correcting device for learning Mandarin as claimed in claim 1, with the reader being a barcode reader, an IC reader, a magnetic strip reader, a radio frequency identification reader, or an optical character recognition reader.
